(19) United States
(12) Patent Application Publication
(10) Pub. No.: US 2010/0109435 A1
(43) Pub. Date: May 6, 2010

(54) Linear Voltage Regulator with Multiple Outputs

(75) Inventors: Mohammad Mahdi Ahmadi, Toronto (CA); Graham Arnold Jullien, Tecumseh (CA)

Correspondence Address: FULBRIGHT & JAWORSKI L.L.P., 600 CONGRESS AVE., SUITE 2400, AUSTIN, TX, 78701, US

(73) Assignee: UTI LIMITED PARTNERSHIP, Calgary (CA)

(21) Appl. No.: 12/568,498

(22) Filed: Sep. 28, 2009

Related U.S. Application Data
(60) Provisional application No. 61/100,565, filed on Sep. 26, 2008.

(51) Int. Cl. H02J 4/00

(52) U.S. Cl. 307/31

(57) ABSTRACT

Systems, methods, and apparatuses that may be employed to generate multiple, regulated, isolated power supply voltages are disclosed. In a first implementation, a system includes a circuit configured to supply a plurality of regulated supply voltages. The circuit may include a voltage regulator that can include a first transistor, where the first transistor can be configured to supply a first regulated supply voltage. The circuit may further include a second transistor, operably coupled to the first transistor, where the second transistor can be configured to supply a second regulated supply voltage.

### CROSS REFERENCE TO RELATED APPLICATIONS

This application claims the benefit of U.S. Provisional Application No. 61/100,565 filed Sep. 26, 2008, the entire contents of which disclosure is specifically incorporated herein by reference without disclaimer.

### TECHNICAL FIELD

This disclosure generally relates to electronic circuitry, and in particular, electronic circuits for voltage regulation.

### BACKGROUND

A variety of electronic circuits, e.g., analog, digital, and/or radio frequency (RF) circuits, can use linear voltage regulators to regulate the voltage level supplied to the circuitry. In some cases, the variety of electronic circuits can be included on a single printed circuit board (PCB). Many of the PCBs can be included in devices where a battery provides the voltage source to operate the device. Therefore, the linear voltage regulators can be included in battery-operated devices on PCBs along with a variety of different types of electronic circuits. These regulators can operate under low voltage, mixed signal conditions. For example, wireless handheld communications and remote-control devices can include mixed analog, digital, and RF circuitry, all in one device. Examples of these devices can include, but are not limited to, cellular phones, wireless devices implanted in living beings, television remote-controls, etc.

Linear voltage regulators can be used in many different types of electronic devices to convert an unregulated—and sometimes noisy—direct current (DC) power supply voltage to a regulated, clean DC power supply voltage.

Many battery-powered portable electronic devices, such as laptop computers, cell phones, and the like, may have at least one linear voltage regulator for regulating the output voltage of the battery into a regulated and clean DC power supply voltage. Additionally, many portable devices that can be powered by other kinds of remote power, such as inductive coupling or electromagnetic radiation, may use a linear voltage regulator to generate a clean DC power supply voltage required for the operation of that electronic device.

In addition, many non-portable electronic devices (e.g., desktop computers, TVs, etc.) may use an alternating current (AC) to DC converter and a linear voltage regulator to convert the AC power supply voltage from, for example, municipal power lines into a clean DC supply voltage required for the operation of the electronic device.

With the growth in circuit integration capabilities, many circuit blocks of an electronic device can be integrated into a single integrated circuit (IC) chip. This can be referred to as a System-On-Chip (SOC).

### SUMMARY OF THE INVENTION

In general, this document describes various systems, methods, and apparatuses that can be used to convert an unregulated, and in some cases, noisy power supply voltage to a clean, e.g., exhibiting a reduced noise spectrum, stable power supply voltage.

In a first aspect, a system includes a circuit configured to supply a plurality of isolated, regulated supply voltages. The circuit further includes a voltage regulator. The voltage regulator further includes a first transistor configured to supply a first regulated supply voltage and a second transistor, operably coupled to the first transistor, configured to supply a second regulated supply voltage, where the first regulated supply voltage and the second regulated supply voltage are electrically isolated from one another.

Implementations can include any, all or none of the following features. The voltage regulator can include an operational amplifier whose output is operably coupled to the first transistor. The voltage regulator can further include at least two resistors operably coupled between an input to the voltage regulator and the first transistor. The first transistor can be a pass transistor. The at least two resistors and the pass transistor can form a feedback loop for the operational amplifier. The pass transistor can be a p-channel metal-oxide-semiconductor (PMOS) transistor. The pass transistor can be an n-channel metal-oxide-semiconductor (NMOS) transistor. The second transistor can be an n-channel metal-oxide-semiconductor (NMOS) transistor. The second transistor can be an n-channel metal-oxide-semiconductor (NMOS) transistor. The first regulated supply voltage can be configured to supply power to analog circuitry. The second regulated supply voltage can be configured to supply power to digital circuitry. Switching noise from the digital circuitry coupled to the second regulated supply voltage may not be coupled onto the first regulated supply voltage. A gate of the first transistor can be operably coupled to an output of the operational amplifier and a gate of the second transistor. A gate of the first transistor can be operably coupled to an output of the operational amplifier and a gate of the second transistor. A gate of the first transistor can be operably coupled to an output of the operational amplifier and a drain of the first transistor can be operably coupled to a gate of the second transistor. A gate of the first transistor can be operably coupled to an output of the operational amplifier and a drain of the first transistor can be operably coupled to a gate of the second transistor. A gate of a third transistor can be operably coupled to said gate of said first transistor. The third transistor can be configured to supply a third regulated supply voltage. The first regulated supply voltage, the second regulated supply voltage, and the third regulated supply voltage can be electrically isolated from one another. An additional resistor can be operably coupled between a drain of the first transistor, and a gate of the second transistor. The additional resistor can be operably coupled to the at least two resistors coupled between the input to the voltage regulator and the first transistor. An additional resistor can be configured to control a value of the second regulated supply voltage. A value for the first regulated supply voltage can substantially match a value for the second regulated supply voltage. Alternatively, a value for the first regulated supply voltage can be different from a value for the second regulated supply voltage. The voltage regulator can include one or more diode-connected transistors operably coupled in series to one another, the first transistor operably coupled to an end of the plurality of diode-connected transistors operably coupled in series to one another, and a resistor operably coupled to the first transistor and the plurality of diode-connected transistors operably coupled in series to one another. A gate of the first transistor can be operably coupled to the plurality of diode-connected transistors operably coupled to one another and a gate of the second transistor. A gate of the first transistor can be operably coupled to the plurality of diode-connected transistors operably coupled to one another, and a gate of the second transistor can be operably coupled to a subset of the plurality of diode-connected transistors operably coupled to one another. The subset of the plurality of diode-connected transistors operably coupled to one another can control a value of the second regulated voltage supply.

In a second aspect, a multi-output voltage regulator, having a first, second, and third input power supply rail includes a single-output linear voltage regulator generating a first output of the multi-output voltage regulator, where the first output can be a first regulated supply voltage. The multi-output voltage regulator, having a first, second, and third input power supply rail further includes at least one pass transistor, operably coupled to the single-output linear voltage regulator, where the pass transistor can be configured to supply at least one additional regulated supply voltage.

Implementations can include any, all or none of the following features. The first and the second power supply rails can be coupled to ground. The second and the third power supply rails are coupled to ground. The single-output linear voltage regulator can be a series-type linear voltage regulator. The single-output linear voltage regulator can be a shunt-type linear voltage regulator. The pass transistors can be field effect transistors (FET). Gate terminals of the field effect transistors can be coupled to the single-output linear voltage regulator, where drain terminals of the field effect transistors can coupled to the first power supply rail and source terminals of the field effect transistors can generate the at least one additional regulated supply voltage. Gate terminals of the field effect transistors are coupled to the single-output linear voltage regulator, where drain terminals of the field effect transistors can be coupled to an output of the single-output linear voltage regulator and source terminals of the field effect transistors can generate the at least one additional regulated supply voltage. The pass transistors can be bipolar transistors. Base terminals of the bipolar transistors can be coupled to the single-output linear voltage regulator, collector terminals of the bipolar transistors can be coupled to the first power supply rail, and emitter terminals of the bipolar transistors can generate the at least one additional regulated supply voltage. Base terminals of the bipolar transistors can be coupled to the single-output linear voltage regulator, collector terminals of the bipolar transistors can be coupled to an output of the single-output linear voltage regulator, and emitter terminals of the bipolar transistors can generate the at least one additional regulated supply voltage.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more implementations are set forth in the accompanying drawings and the description below. Other features, objects, and advantages will be apparent from the description and drawings, and from the claims.

### BRIEF DESCRIPTION OF THE DRAWINGS

The foregoing summary as well as the following detailed descriptions of various implementations will be better understood when read in conjunction with the appended drawings. It should be understood, however, that preferred implementations are not limited to the precise arrangements and instrumentalities shown herein. The components in the drawings are not necessarily to scale, emphasis instead being placed upon illustrating principles of various implementations.

FIG. 1A is an exemplary portable monitoring device that can include a low drop-out linear voltage regulator with multiple outputs, according to one embodiment.

FIG. 1B is an exemplary block diagram of a system on a chip design, according to one embodiment.

FIG. 2A is an additional exemplary multi-output linear voltage regulator according to one embodiment.

FIG. 2B is an additional exemplary multi-output linear voltage regulator according to one embodiment.

FIG. 2C is an additional exemplary multi-output linear voltage regulator, according to one embodiment.

FIG. 3 is an additional exemplary multi-output linear voltage regulator, according to one embodiment.

FIG. 4 is an additional exemplary multi-output linear voltage regulator, according to one embodiment.

FIG. 5A is an additional exemplary multi-output linear voltage regulator, according to one embodiment.

FIG. 5B is an additional exemplary multi-output linear voltage regulator, according to one embodiment.

FIG. 6A is a graph of an exemplary waveform of an analog voltage signal, according to one embodiment.

FIG. 6B is a graph of an alternate exemplary waveform of an analog voltage signal, according to one embodiment.

FIG. 7 is a graph of exemplary time-domain measurement results of output, regulated voltages, according to one embodiment.

Like reference symbols in the various drawings indicate like elements.

### DETAILED DESCRIPTION OF ILLUSTRATIVE EMBODIMENTS

A portable wireless device can use a linear voltage regulator with multiple outputs to regulate the DC voltage to a variety of circuits included in the device. In some implementations, the circuits may be included together on a single integrated chip, which can be referred to as a system on a chip (SOC). For example, a portable wireless device can be a portable, implantable device that can monitor the concentration of biological species (e.g., oxygen, glucose or cholesterol) in human blood. The device can be implanted in a patient and may wirelessly transmit a value representative of the concentration to a receiving device. The receiving device may include a visual indicator that can display the value representative of the concentration level. The patient can view the value of the concentration level to determine if they require any immediate medication. In some implementations, the portable monitoring device may include integrated circuits, which may advantageously function with low power requirements. Therefore, a battery may be used to supply power to the integrated circuits in the device.

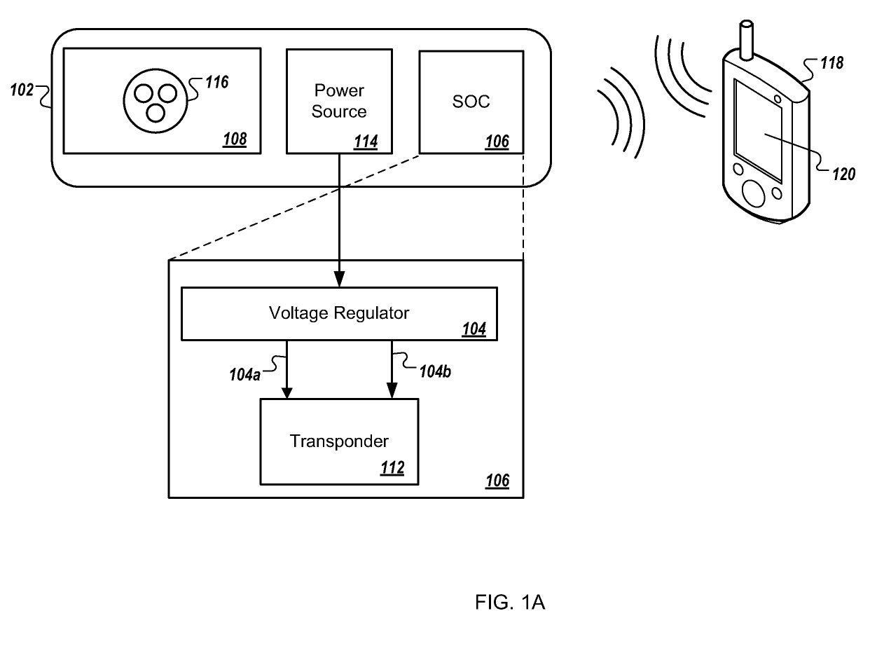

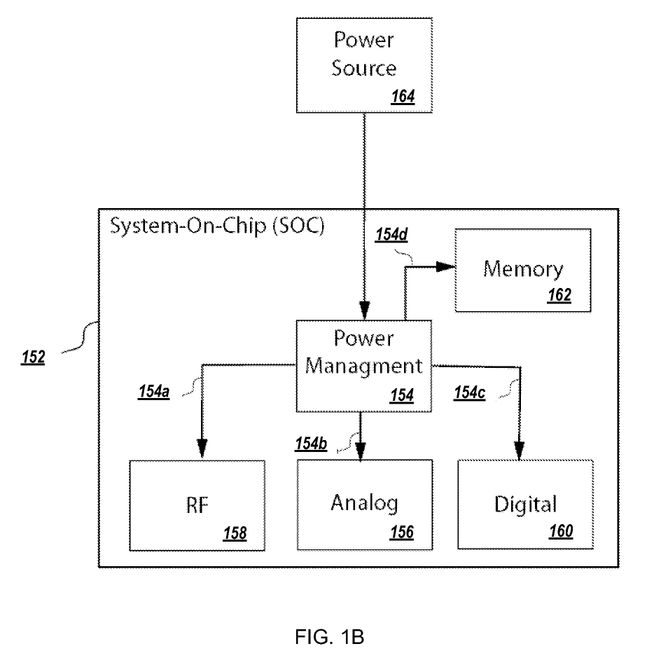

Referring now to FIG. 1A, a portable monitoring device 102 can, in some embodiments, include a system on a chip (SOC) 106 that can include a voltage regulator 104 with multiple outputs 104a, 104b. In the embodiment of FIG. 1, the SOC 106 can also include a transponder 112. A power source 114, included in the portable monitoring device 102, can provide power to the SOC 106. The SOC can be fabricated on a single integrated circuit and can include mixed signal designs (e.g., analog, digital, and RF).

In some implementations, the SOC 106 can be used in a variety of applications that include, but are not limited to, environmental monitoring, food preparation, including industrial food preparation, and biomedical applications. For example, the portable monitoring device 102 can be a wireless implantable device dedicated for blood glucose monitoring that can be implanted into a human body to continuously measure the blood glucose level in the body. In some implementations, an electrochemical cell 116 can be included in an electrochemical sensor circuit 108. The electrochemical cell 116 can include a working electrode, a counter electrode, and a reference electrode. The sensor can be an electrochemical hydrogen peroxide electrode-based glucose biosensor. A current flow through the sensor (e.g., from the working electrode to the counter electrode) can be the result of the oxidation of hydrogen peroxide at the surface of the working electrode of the electrochemical cell 116.

In some implementations, a potentiostat circuit associated with the electrochemical sensor circuit 108 can determine the value of the sensor current. The measured sensor current value can be proportional the amount of hydrogen peroxide that diffuses to the working electrode, which can be proportional to the amount of glucose in the bloodstream. For example, the sensor circuit 108 can convert the measured sensor current value to a voltage. In some implementations, an analog to digital converter can convert the voltage to a digital value (e.g., a numeric value proportional to the voltage). The digital value can be representative of the measured sensor current and therefore representative of the amount of glucose in the bloodstream.

In some implementations, the digital value can be input to the transponder 112. The transponder 112 can transmit a radio frequency signal wirelessly to a receiving device. The transponder 112 can include both digital and analog circuitry that converts a digital value (e.g., the digital value representative of the amount of glucose in the bloodstream) received from the sensor circuit 108 to an analog value. The transponder 112 can modulate the analog value with a radio frequency signal and transmit the RF signal to a receiving device 118. In some implementations, the receiving device 118 can also include a transponder that can receive the RF signal and determine the digital value. The digital value can be translated into a glucose level value that can be output to a display 120.

In some implementations, the SOC 106 can be fabricated using complementary metal oxide semiconductor (CMOS) processes. CMOS circuits can use reduced power while working with low power supply voltages, making them beneficial for use in battery-operated devices. In some implementations, the power source 114 can be a battery. In some implementations, the power source 114 can be an inductive power transfer link. The continuous blood glucose monitoring device can have low power consumption because the power provided to the device (either by a battery or by an inductive power transfer link) is limited.

Referring back to FIG. 1A, the voltage regulator 104 can provide two outputs, 104a, 104b, to the transponder 112 that can be individual, isolated, stable, noise-free voltages. In some implementations, the voltage regulator 104 may provide more than two isolated, regulated output voltages. The number of output voltages supplied by a voltage regulator can be dependent on the number of isolated, regulated voltages used by the circuits included on a SOC. For example, the voltage output 104a can provide power to analog circuitry in the transponder 112 and the voltage output 104b can provide power to digital circuitry in the transponder 112. The isolated outputs 104a, 104b can decrease the likelihood that the switching noise from the digital circuits will be coupled to the analog circuits. This coupling can occur through the power supply rails of the SOC 106. Switching noise coupled to the analog circuitry can degrade the functionality of the analog circuitry.

In some implementations, the voltage regulator 104 can be a linear voltage regulator that can convert a noisy, unstable DC supply voltage (e.g., provided by power source 114) to a noise-free, stable DC supply voltage. In some implementations, the power source 114 can be an alternating current (AC) power source. In this case, the voltage regulator 104 can additionally include circuitry to convert the AC power signal to a DC power signal. In some implementations, the power source 114 can be one or more batteries that can supply the DC power needed to operate the circuitry included in the SOC 106. In this case, the voltage regulator 104 can be a linear voltage regulator that can provide stable DC supply voltages to the circuitry on the SOC 106.

In some implementations, linear voltage regulators can be classified into shunt-type and series-type regulators. In a shunt-type regulator, the regulating device (e.g., a zener diode) can be connected in parallel with a load resistance. In a series-type regulator, the regulating device (e.g., a transistor) can be connected in series with the load resistance. In this implementation, the regulating device can also be referred to as a pass device. In some implementations, a device that uses a shunt-type regulator may consume more power from a power source to drive the same load as a device that uses a series-type regulator. For example, the communication range of a wireless device can be inversely proportional to its power consumption (the less power the device uses, the broader the range). Therefore, a device that includes a shunt-type regulator can degrade the communication range of its wireless link due to its increased power consumption.

In some implementations, in order to prevent noise coupling between voltage regulator outputs, a separate linear voltage regulator can be used for each supply voltage. For example, a first linear voltage regulator can supply an isolated, regulated voltage to analog circuitry, and a second linear voltage regulator can supply an isolated, regulated voltage to digital circuitry. Each regulator may receive its voltage supply from the same power source. The separate regulators can isolate the power to each circuit reducing the likelihood of noise coupling from the digital circuitry to the analog circuitry. In some implementations, the separate voltage regulators can be included with the analog and digital circuitry in a SOC. In some implementations, the voltage regulators may be external to a SOC that includes the analog and digital circuitry. In some implementations, the voltage regulators, the analog circuitry, and the digital circuitry may be implemented using a plurality of integrated circuits.

In some implementations, a voltage regulator may provide a plurality of outputs that can be isolated from one another using an isolation circuit. The isolation circuit can prevent noise coupling from the digital circuitry to the analog circuitry by isolating the analog supply rail in the voltage regulator from the digital supply rail.

The use of separate voltage regulators and/or isolation circuits in a voltage regulator, in all likelihood, can increase the power consumption of a device. The die area and the complexity of the chip may also increase when the separate voltage regulators and/or isolation circuits, and digital and analog circuitry are included together in a SOC. In cases where supply power is limited and may need to be conserved (e.g., battery supplied power), the use of separate voltage regulators may not be desirable.

In some implementations, the power consumption of a SOC can be decreased by using a single linear voltage regulator with multiple, isolated, regulated outputs. For example, a linear voltage regulator (e.g., a series-type) can generate an analog supply voltage to power analog circuitry. One of the node voltages of the linear voltage regulator generating the analog supply voltage can control the gate (or base) of one or more pass devices, where each pass device can generate a digital supply voltage. The node voltages in the linear voltage regulator can supply a constant voltage that can be used for gate (or base) control of the pass devices. This can result in a single linear voltage regulator generating a plurality of isolated, regulated output voltages.

Referring now to FIG. 1B, an exemplary block diagram of a system on a chip design (SOC) 152 can include analog circuit block 156, radio frequency (RF) circuit block 158, digital circuit block 160, memory circuit block 162, and power management circuit block 164. In some implementations, other circuit blocks may be included.

Analog circuit block 156 and RF circuit block 158 can include circuits that may be sensitive to electric noise. In some implementations, the electric noise can come from the elements included in the circuit. In some implementations, the electric noise can be injected from other circuits through bias rails, power supply rails, or the substrate of the chip. In some implementations, the electric noise may come from the external environment of the SOC.

In contrast to the analog and RF blocks, digital and memory blocks can be less sensitive to noise. Instead, they may generate substantial noise due to the voltage and/or current switching happening in these blocks. In some implementations, switching noise can penetrate into analog and RF blocks through the power supply rails and/or substrate of the SOC and degrade the performance of those blocks.

In some implementations, a power management block 104 can receive power from an external power source 164 (e.g. a battery or an AC-DC converter) and can generate different supply voltages for the different circuit blocks in the SOC 152. In some implementations, the generation of different power supply voltages can be to prevent the switching noise of noisy circuits, such as the digital 160 and memory 162 blocks, from injecting into sensitive analog circuits such as the analog 156 and RF 158 blocks. In some implementations, the generation of different power supply voltages can be that different circuit blocks need different supply voltages.

The power management block 154 can include several voltage regulators, each one generating a single supply voltage for one or more circuit blocks. This approach can consume a relatively high amount of power because each supply voltage requires a separate voltage regulator. As a result, there may be a need for a voltage regulator that can generate multiple and different output voltages with low power consumption.

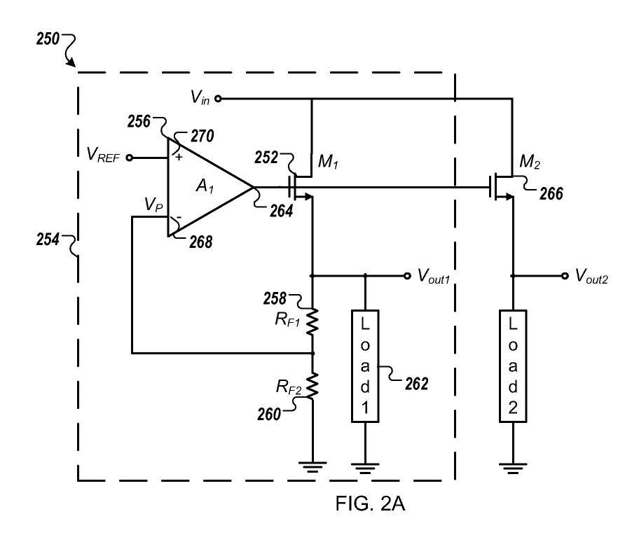

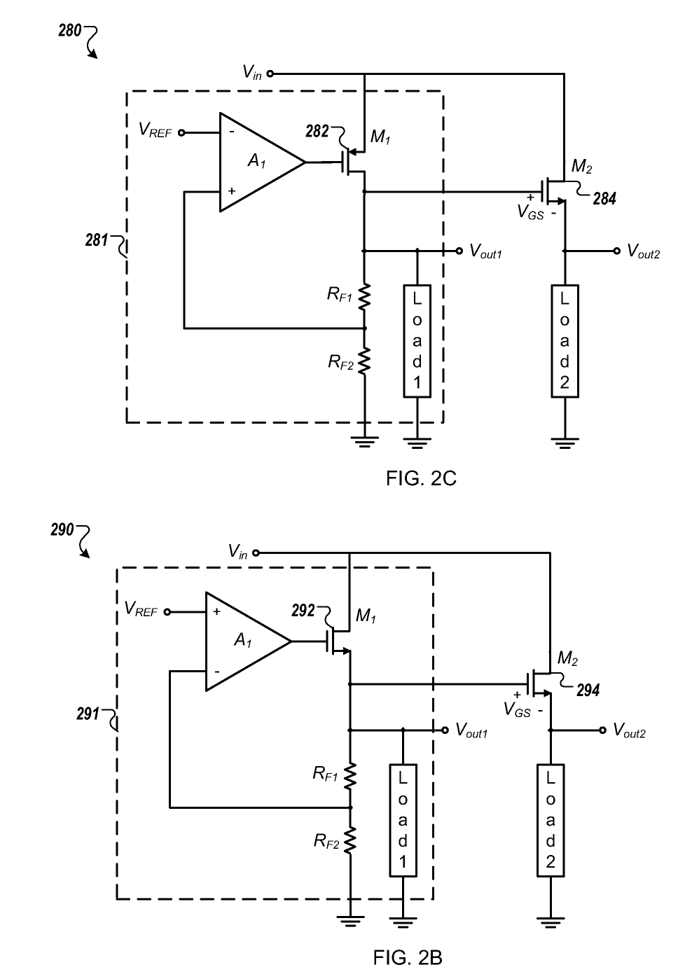

Referring to FIG. 2A, a first input 268 to the amplifier 256 can be a voltage, V_{P}, which can be a percentage of the first output voltage, Vₒᵤₜ₁, where the percentage is determined by the resistor ratio of resistor 258 (R_{F1}) and resistor 260 (R_{F2}) (e.g., V_{P}=Vₒᵤₜ₁*(R_{F1}/R_{F1}+R_{F2})). The first input 268 can monitor the voltage, V_{P}. A second input 270 (V_{REF}) to the amplifier 256 can be a stable voltage reference (e.g., a bandgap reference). If the first output voltage, Vₒᵤₜ₁ increases to a voltage that is greater than the second input 270 (V_{REF}), which is the reference voltage, the drive to the transistor 252 can change to maintain a constant voltage for the first output voltage, Vₒᵤₜ₁. Therefore, the feedback loop can stabilize the regulated first output voltage, Vₒᵤₜ₁, of the series-type voltage regulator 254 to a pre-defined DC voltage.

The series-type voltage regulator 254 can include the NMOS pass transistor 252. A feedback loop to the amplifier 206 can include pass transistor 252 and resistors 258, 260. The feedback loop can be implemented in a source follower configuration and can act as a control loop to control the gate of the pass transistor 252. In some implementations, the use of a control loop in a source follower configuration in a series-type voltage regulator (as shown in FIG. 2A), in all likelihood, can increase the stability of the voltage regulator as compared to the use of a control loop in a common source configuration (as shown in FIG. 2A). Referring again to FIG. 2A, connecting an external capacitor across a load 262 (load1) is no longer required due to the inherently low output impedance of the source follower configuration. The first output voltage, Vₒᵤₜ₁, of the series-type voltage regulator 254 can be at least one gain-to-source voltage drop (V_{GS}) below the input supply voltage, Vᵢₙ. In some implementations, this additional voltage drop may be a disadvantage.

In some implementations, the series-type voltage regulators of FIG. 2A regulator 254 can be used in low drop out voltage (LDO) regulators as each regulator uses a single pass device (e.g., pass transistor 252). In some implementations, where a power supply (e.g., power supply 114 in FIG. 1) can include one or more batteries, a voltage regulator (e.g., regulator 254) can be implemented as a low drop out voltage regulator. For example, a LDO voltage regulator can be a linear voltage regulator, which can operate with a small input-output differential voltage. In some implementations, a charge pump may be used to provide a supply voltage that is slightly higher that an input reference voltage to a series-type voltage regulator, such as those shown in FIG. 2A in order to allow the regulator 254 to function as a low drop-out voltage regulator.

As previously described, a linear voltage regulator may provide a regulated voltage to mixed signal circuitry (e.g., analog, digital, and RF) included in a SOC. In a system where a single regulator supplies voltage to multiple circuit types, unwanted noise can be coupled from one circuit type to another. For example, switching noise from the digital circuitry can be coupled to the analog circuitry. This can result in undesired effects in the analog circuitry. Various circuits and methods have been described herein to provide separate, isolated voltages to the various circuit types without any negative effects.

A series-type linear voltage regulator 254 can provide a first output voltage, Vₒᵤₜ₁, generated by the pass transistor 252 to a circuit (e.g., analog circuitry). The pass transistor 252 can generate the first voltage, Vₒᵤₜ₁, in the closed loop feedback of the series-type voltage regulator 254. An output 264 of the operational amplifier 256 can be a well-defined, stable voltage. The output 264 can control the gate of a transistor 256 (M₂). The transistor 256 can generate a second output voltage, Vₒᵤₜ₂, in an open loop circuit. The second output voltage, Vₒᵤₜ₂, can be isolated from the first output voltage, Vₒᵤₜ₁. The pass transistor in the series-type regulator can effectively be divided into two transistors, the pass transistor 252 and a second transistor 266. In some implementations, the multi-output linear voltage regulator 250 can use the pass transistor 252 and the second transistor 266 to generate separate, isolated voltages (Vₒᵤₜ₁ and Vₒᵤₜ₂, respectively) that can be supplied to analog circuitry and digital circuitry, respectively.

In some implementations, the second transistor 266 can consume little to no additional power from the input supply voltage, Vᵢₙ. The second transistor 266 may also add little to no additional die area or complexity to the SOC that includes the multi-output linear voltage regulator 250. The multi-output linear voltage regulator 250 can divide the pass device for the series-type regulator into two transistors, the pass transistor 252 and the second transistor 266. The two transistors, transistor 252 and transistor 266, can each generate a separate, isolated, regulated supply voltage, (Vₒᵤₜ₁ and Vₒᵤₜ₂, respectively). In some implementations, a pass transistor can be divided into more than two transistors, each of which can generate a separate, isolated, regulated supply voltage, which can then be connected to various types of circuitry.

In some implementations, the feedback loop for the series-type voltage regulator 254 can maintain the first output voltage, Vₒᵤₜ₁, at a desired pre-defined voltage. The second output voltage, Vₒᵤₜ₂, in some cases, may not be as well-defined a voltage as the first output voltage, Vₒᵤₜ₁, because the control circuit for the second output voltage, Vₒᵤₜ₂, is open loop. In some implementations, the second voltage, Vₒᵤₜ₂, can be a supply voltage for digital circuits because the digital circuits may not require a tightly regulated supply voltage. The isolation of the first supply voltage, Vₒᵤₜ₁, from the second supply voltage, Vₒᵤₜ₂, and vice versa can be limited by the coupling due to the gate-to-source capacitances of the divided pass transistors 252 and 266.

In some implementations, a pass device may be an alternate type of transistor (e.g., a bipolar transistor). In some implementations, a pass device may be a combination of bipolar transistors coupled to form, for example, a Darlington transistor pair. In some implementations, the feedback resistors may be replaced by diodes or diode connected transistors.

In one embodiment, the first output voltage, Vₒᵤₜ₁, can be essentially equal to the second output voltage, Vₒᵤₜ₂, as the gates of both transistors 252 and 266 are coupled to the output of the operational amplifier output 264. In some implementations, the base of the second transistor may be coupled to the gate of a second transistor may be coupled to the drain or source of a pass transistor. In these implementations, the output voltage of the second transistor will vary from the regulated output voltage of the pass transistor.

In a linear voltage regulator, the transistor that is in the path of the electric current flow from the input terminal to the output terminal of the regulator can be referred to as a pass transistor. The pass transistor of a linear regulator can be a field effect transistor (FET), bipolar or other type of transistor. It can also be a combination of a number of transistors, for example, a Darlington transistor pair.

In a multi-output voltage regulator used in this embodiment, a conventional single-output linear voltage regulator, either a series-type or a shunt-type, can be used to generate one of the outputs of the multi-output regulator, and one or more additional pass transistors can be used to generate additional output voltages. The gate (or base) terminals of the additional pass elements can be coupled to nodes, with relatively constant potentials, of the single-output regulator.

Referring back to FIG. 2A, transistor M₁ can act as the pass transistor of the conventional single-output regulator 254. In operation, the output Vₒᵤₜ₁ of regulator 254 can be a constant and stable voltage. In operation, the output 264 of amplifier A₁ equals Vₒᵤₜ₁+V_{GS1}, where V_{GS1} is the gate-to-source voltage (V_{GS}) drop of transistor M₁. In operation, transistor M₁ can operate in a saturation region and therefore its V_{GS} voltage can be relatively constant. Therefore, the output voltage 264 of amplifier A₁ can also be relatively constant. In regulator 250, the output 264 of amplifier A₁ can control the gate terminal of a second pass transistor M₂ that generates a second output Vₒᵤₜ₂ of regulator 250. Vₒᵤₜ₂ is given by Vₒᵤₜ₂=Vₒᵤₜ₁+V_{GS1}−V_{GS2}. In operation, both transistors M₁ and M₂ can work in saturation, thus both V_{GS1} and V_{GS2} are relatively constant. By adjusting the aspect ratio (W/L) of transistors M₁ and M₂, it may be possible to make Vₒᵤₜ₂ greater than, lower than, or almost equal to Vₒᵤₜ₁.

The regulator 250 can generate two regulated outputs; however, it may be possible to add more pass transistors in order to generate more output voltages. The output Vₒᵤₜ₁ of regulator 250 can be better controlled than the output Vₒᵤₜ₂ because Vₒᵤₜ₁ is controlled with the closed-loop negative feedback loop generated by amplifier A₁, transistor M₁, resistor R_{F1} and resistor R_{F2}; the resistor divider, consisting of resistor R_{F1} and resistor R_{F2}, samples the output Vₒᵤₜ₁ and feeds back the sample to the negative input of amplifier A₁. The output of amplifier A₁ moves according to the sampled voltage of Vₒᵤₜ₁ such that transistor M₁ keeps Vₒᵤₜ₁ at a desired voltage level. Vₒᵤₜ₂ can be generated in an open-loop circuit topology, meaning that Vₒᵤₜ₂ changes depending on the current in load2 and there is no feedback mechanism to re-adjust Vₒᵤₜ₂. Therefore, Vₒᵤₜ₁ can be used for circuits that need precise supply voltage, such as analog and RF circuits, while output Vₒᵤₜ₂ can be used for digital and memory blocks.

Compared to two conventional regulators generating two different output voltages, the regulator 250 shown in FIG. 2A, can be advantageous in terms of power consumption, because it can generate two different output voltages while consuming the power of only one regulator. In addition, regulator 250 can occupy a smaller integrated circuit chip area and can be less complex to design.

Compared to one conventional regulator (similar to the regulator 254) generating a single supply voltage for all the circuit blocks in an SOC, the regulator 250 can be advantageous because it consumes the same amount of power and consumes the same integrated circuit chip area, while it can isolate the supply voltage of sensitive-to-noise blocks from noisy supply voltages.

Referring now to FIG. 2B, an exemplary multi-output linear voltage regulator 290 with multiple, isolated, regulated output voltages, Vₒᵤₜ₁ and Vₒᵤₜ₂, can include a second transistor 294 (M₂) whose gate is coupled to the source of a pass transistor 292 (M₁), according to one embodiment. Referring to FIG. 2B, the pass transistor 292 (M₁) can be an NMOS transistor. The voltage regulator 290 can function in a similar manner as the voltage regulator 250 in FIG. 2A.

Regulator 291 can be a conventional single-output linear voltage regulator similar to regulator 254. The combination of amplifier A1, transistor M1, resistor RF1 and resistor RF2 can generate a negative feedback loop which can keep the output Vₒᵤₜ₁ of regulator 291 at a constant voltage given by Vₒᵤₜ₁=V_{REF}*(R_{F1}+R_{F2})/R_{F2}.

In regulator 291, transistor M₁ can act as the pass transistor. Regulator 290 can be implemented by adding a second pass transistor M₂ to regulator 291. The pass transistor M₂ can generate a second output Vₒᵤₜ₂ of the regulator 290. In operation, the output Vₒᵤₜ₁ can be a constant and stable voltage. In regulator 290, the gate terminal of the pass transistor M₂ can be coupled to the output Vₒᵤₜ₁ which can have a relative constant and well-defined value. Vₒᵤₜ₂ is given by Vₒᵤₜ₂=Vₒᵤₜ₁−V_{GS2}. In operation, transistor M₂ can operate in a saturation mode, thus V_{GS2} can be relatively constant, making Vₒᵤₜ₂ a relatively constant and stable supply voltage.

In regulator 290, Vₒᵤₜ₂ can be less than Vₒᵤₜ₁. By adjusting the aspect ratio (W/L) of transistor M₂, it may be possible to adjust the voltage difference between Vₒᵤₜ₁ and Vₒᵤₜ₂. It may also be possible to use a native or low threshold voltage NMOS transistor to realize transistors M₁ and M₂. In that case, it may be possible to make Vₒᵤₜ₂ relatively equal to Vₒᵤₜ₁.

Regulator 290 can have similar advantages to regulator 250 when compared to multiple regulators generating multiple supply voltage for different circuit blocks of a SOC, or compared to a single regulator generating a single supply voltage for all circuit blocks of the SOC.

Referring now to FIG. 2C, an exemplary multi-output linear voltage regulator 280 with multiple, isolated, regulated output voltages, Vₒᵤₜ₁ and Vₒᵤₜ₂, can include a second transistor 284 (M₂) whose gate is coupled to the drain of a pass transistor 282 (M₁), according to one embodiment. Referring to FIG. 2C, the pass transistor 282 (M₁) can be a PMOS transistor.

Regulator 281 can be a conventional voltage regulator similar to regulator 291, but instead of using an NMOS transistor as the pass element, a PMOS transistor M₁ can be used as the pass element in regulator 281. This can reduce the voltage drop from Vᵢₙ to Vₒᵤₜ₁. The combination of amplifier A₁, transistor M₁, resistor R_{F1} and resistor R_{F2} can generate a negative feedback loop which can keep the output Vₒᵤₜ₁ of regulator 281 at a constant voltage given by Vₒᵤₜ₁=V_{REF}*(R_{F1}+R_{F2})/R_{F2}.

Regulator 280 can be implemented by adding a second pass transistor M₂ to the single-output voltage regulator 281. The pass transistor M₂ can generate a second output Vₒᵤₜ₂ of the regulator 280. In operation, the output Vₒᵤₜ₁ can be a constant and stable voltage. In regulator 280, the gate terminal of the pass transistor M₂ can be coupled to the output Vₒᵤₜ₁. Vₒᵤₜ₂ is given by Vₒᵤₜ₂=Vₒᵤₜ₁−V_{GS2}. In operation, transistor M₂ can operation in a saturation mode, thus V_{GS2} can be relatively constant, making Vₒᵤₜ₂ a relatively constant and stable supply voltage.

In regulator 280, Vₒᵤₜ₂ can be less than Vₒᵤₜ₁. By adjusting the aspect ratio (W/L) of transistor M₂, it may be possible to adjust the voltage difference between Vₒᵤₜ₁ and Vₒᵤₜ₂. It may also be possible to use a native or low threshold voltage NMOS transistor to realize transistor M₂. In that case, it may be possible to make Vₒᵤₜ₂ relatively equal to Vₒᵤₜ₁.

Regulator 280 can have similar advantages to regulator 250 when compared to multiple regulators generating multiple supply voltage for different circuit blocks of a SOC, or compared to a single regulator generating a single supply voltage for all circuit blocks of the SOC.

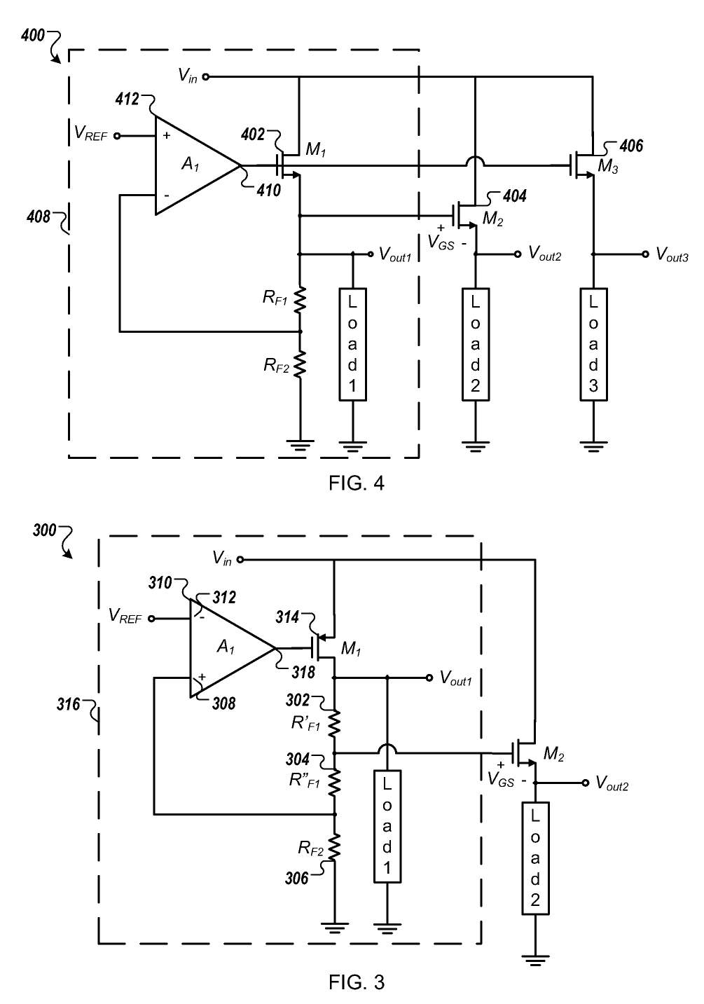

Referring now to FIG. 3, an exemplary multi-output linear voltage regulator 300 with multiple, isolated, regulated output voltages, Vₒᵤₜ₁, and Vₒᵤₜ₂ can include a plurality of feedback resistors (resistor 302 (R′_{F1}), resistor 304 (R″_{F1}), and resistor 306 (R_{F2})), according to one embodiment. The voltage regulator 300 can function in a similar manner as the voltage regulator 280 in FIG. 2D.

Referring to FIG. 3, a first input 208 to an operational amplifier 310 can be a voltage, V_{P}, which can be a percentage of the first output voltage, Vₒᵤₜ₁, where the percentage is determined by the resistor ratio of resistor 208 (R′_{F1}), resistor 304 (R″_{F1}) and resistor 306 (R_{F2}) (e.g., V_{P}=Vₒᵤₜ₁*((R′_{F1}+R″_{F1})/R′_{F1}+R″_{F1}+R_{F2})). The first input 218 can monitor the voltage, V_{P}. A second input 312 (V_{REF}) to the amplifier 310 can be a stable voltage reference (e.g., a bandgap reference). A PMOS pass transistor 314 (M₁) can be coupled to an output 318 of the operational amplifier 310. If the first output voltage, Vₒᵤₜ₁, increases to a voltage that is greater than the second input 312 (V_{REF}), which is the reference voltage, the drive to a pass transistor 314 can change to maintain a constant voltage for the first output voltage, Vₒᵤₜ₁. Therefore, the feedback loop can stabilize the regulated first output voltage, Vₒᵤₜ₁, of the series-type voltage regulator 316 to a pre-defined DC voltage.

Referring to FIG. 3, the second output voltage, Vₒᵤₜ₂, can be equal to the first output voltage, Vₒᵤₜ₁, minus the sum of the gate-to-source voltage drop across the second transistor 304 (M₂) and the voltage drop across the resistor 302 (R′_{F1}). The value of resistor 302 (R′_{F1}) can be selected to control the value of the second output voltage, Vₒᵤₜ₂.

Regulator 316 can be a conventional single-output voltage regulator similar to regulator 281 with the only difference being that resistor R_{F1} in regulator 281 is realized with the series connection of two resistors R′_{F1} and R″_{F1} as shown in FIG. 3. The combination of amplifier A₁, transistor M₁, resistor R′_{F1}, resistor R″_{F1} and resistor R_{F2} generate a negative feedback loop by which the output Vₒᵤₜ₁ of regulator 316 is kept at a constant voltage given by Vₒᵤₜ₁=V_{REF}*(R′_{F1}+R″_{F1}+R_{F2})/R_{F2}.

Regulator 300 can be implemented by adding a second pass transistor M₂ to the conventional regulator 316. The pass transistor M₂ can generate a second output Vₒᵤₜ₂ of the regulator 300. In operation, the output Vₒᵤₜ₁ can be a constant and stable voltage. In regulator 300, the gate terminal of the pass transistor M₂ can be coupled to the node which couples R′_{F1} to R″_{F1}. Vₒᵤₜ₂ is given by Vₒᵤₜ₂=(R″_{F1}+R_{F2})/(R′_{F1}+R″_{F1}+R_{F2})Vₒᵤₜ₁−V_{GS2}. In operation, transistor M₂ can operate in a saturation mode, thus V_{GS2} can be relatively constant, making Vₒᵤₜ₂ a relatively constant and stable supply voltage.

In regulator 300, Vₒᵤₜ₂ can be less than Vₒᵤₜ₁. By adjusting the aspect ratio (W/L) of transistor M₂ and the ratios among resistors R′_{F1}, R″_{F1}, and R_{F2}, it may be possible to adjust the voltage difference between Vₒᵤₜ₁ and Vₒᵤₜ₂.

Regulator 300 can have similar advantages to regulator 250 when compared to multiple regulators generating multiple supply voltage for different circuit blocks of a SOC, or compared to a single regulator generating a single supply voltage for all circuit blocks of the SOC.

Referring now to FIG. 4, an exemplary multi-output linear voltage regulator 400 with multiple, isolated, regulated output voltages, Vₒᵤₜ₁, Vₒᵤₜ₂, and Vₒᵤₜ₃, can include a gate of a second transistor 404 (M₂) coupled to a source of a PMOS pass transistor 402 (M₁), and a gate of a third transistor 406 (M₃) coupled to an output 410 of an operational amplifier 412, according to one embodiment. The PMOS pass transistor 402 (M₁) can also be coupled to the output 410 of the operational amplifier 412. A voltage regulator 408 can function in a similar manner as the voltage regulator 290 in FIG. 2D. The voltage regulator 400 additionally includes the third transistor 406 (M₃) that generates the third isolated regulated output voltage, Vₒᵤₜ₃. Referring to FIG. 4, the second output voltage, Vₒᵤₜ₂, is equal to the first output voltage, Vₒᵤₜ₁, minus the gate-to-source voltage drop across the second transistor 404 (M₂). The third transistor 406 (M₃) can generate the third output voltage, Vₒᵤₜ₃, which is essentially equal to the first output voltage, Vₒᵤₜ₁.

The exemplary multi-output voltage regulators 250, 280, 290 and 300 shown in FIGS. 2 and 3 can generate two output voltages: Vₒᵤₜ₁ and Vₒᵤₜ₂; however, these regulators can be modified to generate more than two output voltages. For example, FIG. 4 shows an exemplary multi-output voltage regulator 400, which can generate three output voltages. The NMOS pass transistors M₂ and M₃ can be coupled to a conventional single-output voltage regulator 408 to generate two additional voltage outputs: Vₒᵤₜ₂ and Vₒᵤₜ₃. In operation, nodes in the regulator 408, which have relatively constant potentials, can control the gates of transistors M₂ and M₃. Regulator 400 can operate similarly to regulators 250 and 290. Similar to the voltage output Vₒᵤₜ₂ of regulator 250, the output Vₒᵤₜ₃ of regulator 400 can be related to Vₒᵤₜ₁ by: Vₒᵤₜ₃=Vₒᵤₜ₁+V_{GS1}−V_{GS3}. In operation, both transistors M₁ and M₃ can operate in a saturation mode, thus both the voltages V_{GS1} and V_{GS2} can be relatively constant.

By adjusting the aspect ratio (W/L) of transistors M₁ and M₃, it may be possible to make Vₒᵤₜ₂ greater than, lower than, or almost equal to Vₒᵤₜ₁.

Similar to Vₒᵤₜ₂ of regulator 290, the output Vₒᵤₜ₂ of regulator 4300 can be related to voltage Vₒᵤₜ₁ by: Vₒᵤₜ₂=Vₒᵤₜ₁−V_{GS2}. In operation, transistor M₂ can operate in a saturation mode, thus V_{GS2} can be relatively constant, making Vₒᵤₜ₂ a relatively constant and stable supply voltage. In regulator 400, Vₒᵤₜ₂ can be less than Vₒᵤₜ₁. By adjusting the aspect ratio (W/L) of transistor M₂, it may be possible to adjust the voltage difference between Vₒᵤₜ₁ and Vₒᵤₜ₂.

The regulator 400 can generate three regulated voltage outputs: Vₒᵤₜ₁, Vₒᵤₜ₂ and Vₒᵤₜ₃; however, it may be possible to add more pass elements in order to generate more than three output voltages. For example, it may be possible to add a fourth NMOS pass transistor to regulator 400 such that the gate terminal of the fourth pass transistor is coupled to the node, which is connected to the negative input of amplifier A₁, and its drain terminal is coupled to Vᵢₙ. The source of the fourth pass transistor can generate a fourth output of the regulator. The voltage output Vₒᵤₜ₁ of regulator 400 can be better controlled than the voltage outputs Vₒᵤₜ₂ and Vₒᵤₜ₃ because voltage Vₒᵤₜ₁ can be controlled in the closed-loop negative feedback loop generated by amplifier A₁, transistor M₁, resistor R_{F1} and resistor R_{F2}; the resistor divider, which includes R_{F1} and R_{F2}, can sample the voltage output Vₒᵤₜ₁ and can feed back the voltage sample to the negative input of amplifier A₁. The output of amplifier A₁ can move according to the sampled voltage of Vₒᵤₜ₁ such that transistor M₁ can keep voltage Vₒᵤₜ₁ at a desired voltage level. Voltages Vₒᵤₜ₂ and Vₒᵤₜ₃ can be generated in open-loop circuit topologies, meaning that voltages Vₒᵤₜ₂ and Vₒᵤₜ₃ can change depending on the currents in load2 and load3 and there is no feedback mechanism to re-adjust voltages Vₒᵤₜ₂ and Vₒᵤₜ₃. Therefore, voltage Vₒᵤₜ₁ can be used for circuits that need precise supply voltage, such as analog and RF circuits, while voltage outputs Vₒᵤₜ₂ and Vₒᵤₜ₃ can be used for digital and memory blocks.

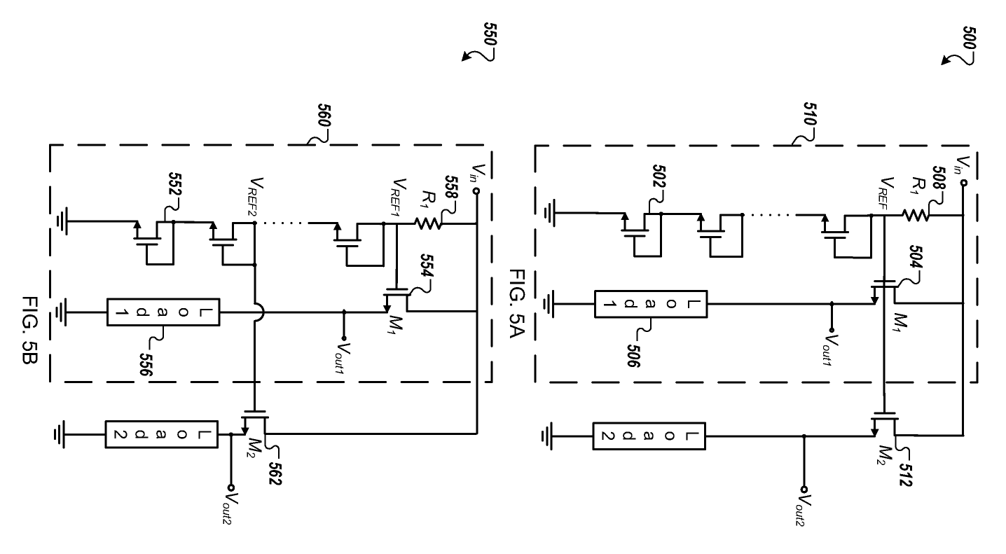

Referring to FIGS. 5A and 5B, exemplary multi-output linear voltage regulators 500 and 550 with multiple, isolated, regulated output voltages, Vₒᵤₜ₁, and Vₒᵤₜ₂ can include a plurality of diode-connected transistors, according to one embodiment. The implementations in FIGS. 5A and 5B do not use a feedback loop to control and stabilize the first output voltage, Vₒᵤₜ₁. Alternatively, the implementations in FIGS. 5A and 5B can control the first output voltage, Vₒᵤₜ₁, using an open loop configuration. Transistor 502 and transistor 552 are representative of a diode-connected transistor in FIG. 5A and FIG. 5B, respectively.

All the output voltages of the multi-output regulators, 500 and 550, shown in FIGS. 5A and 5B can be controlled with open-loop circuits. In FIGS. 5A and 5B, a number of diode-connected MOS transistors can be connected in series. Transistor 502 and transistor 552 are representative of a diode-connected transistor in FIG. 5A and FIG. 5B, respectively. In operation, there can be a current flowing in these diode-connected transistors, thus the V_{GS} of these diode-connected transistors can be relatively constant. Thus, the sum of the V_{GS} of these diode-connected transistors can be relatively constant and can be used for controlling the gate (or base) of one or more pass devices of a linear voltage regulator.

Referring to FIG. 5A, the multi-output linear voltage regulator 500 can include an open loop controlled series-type voltage regulator 510. The value of resistor 508 (R₁) can be selected to control the amount of current flowing through the diode-connected transistors such that the transistors operate in their saturation region providing a constant drain-to-source voltage. The number of diode-connected transistors connected in series can determine the voltage at the gate of pass transistor 504 (M₁). The pass transistor 504 (M₁) can act as the regulating device in the voltage regulator 500. The pass transistor 504 (M₁) can be placed in series with the load resistance 506. The gate of the pass transistor 504 (M₁) can be coupled to the resistor 508 (R₁) and the top of the series connection of diode-connected transistors.

Referring again to FIG. 5A, the first output voltage, Vₒᵤₜ₁, generated by the pass transistor 504 can be coupled to a circuit (e.g., analog circuitry). A second transistor 512 (M₂) can be coupled to the gate of the pass transistor 504 (M₁) which is coupled to the resistor 508 (R₁) and the top of the series connection of diode-connected transistors. The second transistor 512 (M₂) can generate a second output voltage, Vₒᵤₜ₂, in an open loop circuit. The second output voltage, Vₒᵤₜ₂, can be isolated from the first output voltage, Vₒᵤₜ₁. The pass transistor in the series-type regulator can effectively be divided into two transistors, the pass transistor 504 (M₁) and the second transistor 512 (M₂). In some implementations, the multi-output linear voltage regulator 500 can use the pass transistor 504 (M₁) and the second transistor 512 (M₂) to generate separate, isolated voltages (Vₒᵤₜ₁ and Vₒᵤₜ₂, respectively) that can be supplied to analog circuitry and digital circuitry, respectively.

Referring to FIG. 5B, the multi-output linear voltage regulator 550 can include an open loop controlled series-type voltage regulator 560. The value of resistor 558 (R₁) can be selected to control the amount of current flowing through the diode-connected transistors such that the transistors operate in their saturation region providing a constant drain-to-source voltage. The number of diode-connected transistors connected in series can determine the voltage at the gate of pass transistor 554 (M₁). The pass transistor 554 (M₁) can act as the regulating device in the voltage regulator 550. The pass transistor 554 (M₁) can be placed in series with the load resistance 556. The gate of the pass transistor 554 (M₁) can be coupled to the resistor 558 (R₁) and the top of the series connection of diode-connected transistors.

Referring again to FIG. 5B, the first output voltage, Vₒᵤₜ₁, generated by the pass transistor 554 can be coupled to a circuit (e.g., analog circuitry). A second transistor 562 (M₂) can be coupled to the series connection of the diode-connected transistors at a connection point below the top of the series connection. The connection point can be selected based on the desired regulated voltage value for the second output voltage, Vₒᵤₜ₂. The second transistor 562 (M₂) can generate a second output voltage, Vₒᵤₜ₂, in an open loop circuit. The second output voltage, Vₒᵤₜ₂, can be isolated from the first output voltage, Vₒᵤₜ₁. The pass transistor in the series-type regulator can effectively be divided into two transistors, the pass transistor 554 (M₁) and the second transistor 562 (M₂). In some implementations, the multi-output linear voltage regulator 550 can use the pass transistor 554 (M₁) and the second transistor 562 (M₂) to generate separate, isolated voltages (Vₒᵤₜ₁ and Vₒᵤₜ₂, respectively) that can be supplied to analog circuitry and digital circuitry, respectively.

Referring to FIG. 5A, the value of resistor 508 (R₁) can be selected to control the amount of current flowing through the diode-connected transistors. The number of diode-connected transistors can determine the reference voltage (V_{REF}) at the gate of pass transistors 504 (M₁) and 512 (M₂). The pass transistor M₁ can generate a first output Vₒᵤₜ₁ and the pass transistor M₂ can generate a second output Vₒᵤₜ₂. Voltage Vₒᵤₜ₁ can be given by Vₒᵤₜ₁=V_{REF}−V_{GS1}, and voltage Vₒᵤₜ₂ can be given by: Vₒᵤₜ₂=V_{REF}−V_{GS2}.

Regulator 550 shown in FIG. 5B can operate in a manner similar to the regulator 500 shown in FIG. 5A, but different reference voltages can be used to control the gates of pass transistors M₁ and M₂. The pass transistor M₁ can generate a first voltage output Vₒᵤₜ₁ and the pass transistor M₂ can generate a second voltage output Vₒᵤₜ₂. Voltage Vₒᵤₜ₁ can be given by Vₒᵤₜ₁=V_{REF1}−V_{GS1}, and voltage Vₒᵤₜ₂ can be given by: Vₒᵤₜ₂=V_{REF2}−V_{GS2}.

The exemplary regulator circuit 250 shown in FIG. 2B can be implemented in a transponder chip designed for a wireless implantable microsystem dedicated for blood glucose monitoring. The transponder chip, which was a SOC, was fabricated using a Taiwan Semiconductor Manufacturing Company (TSMC) 0.18 μm complementary metal-oxide-semiconductor (CMOS) process. The desired output voltages, due to system design criteria, were 1.9 volts for the first output voltage, Voutl, and 1.8 volts for the second output voltage. Voltage Vout1 was used as the supply voltage of analog circuits in the transponder chip and Vout2 was used as the supply voltage for the digital circuits.

Amplifier 256 (A₁) was realized using a simple single-stage single-output differential pair amplifier. In order to achieve low-drop-out voltage regulation, both transistors M₁ and M₂ are realized by native NMOS transistors, which are available in almost all modern CMOS technologies.

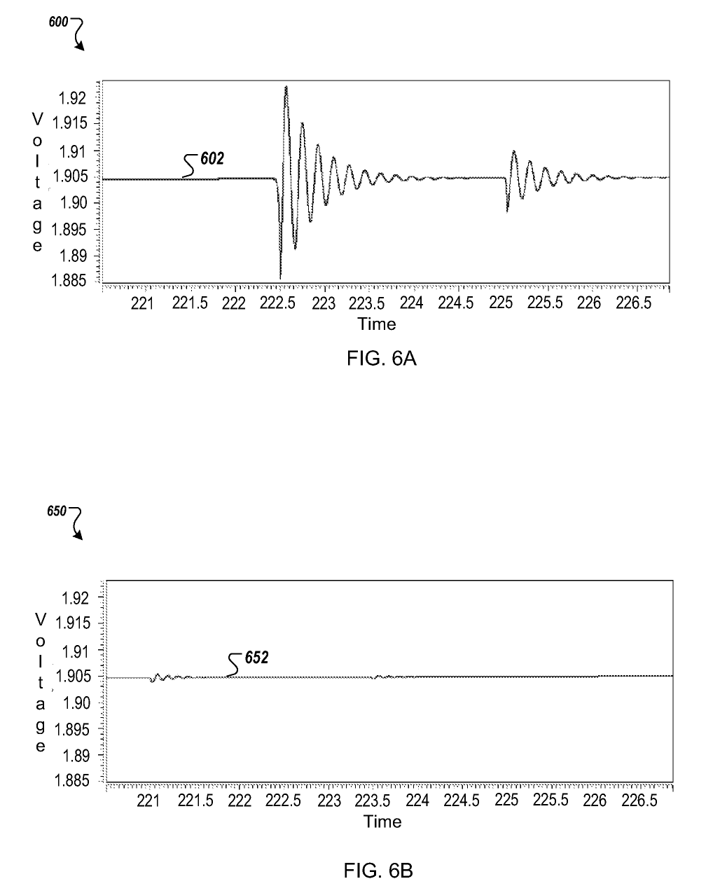

Referring to FIG. 6A, a graph 600 of an exemplary waveform 602 can be of a voltage signal supplied to analog circuitry in an SOC, according to one embodiment. Referring to FIG. 6B, a graph 650 of an alternate exemplary waveform 652 can be of a voltage signal supplied to analog circuitry, according to one embodiment. For example, referring to FIG. 2B, the voltage regulator 250 can be used, now referring to FIG. 1, as the voltage regulator 104 in the SOC 106 that includes the transponder 112. The SOC 116 can be fabricated using a Taiwan Semiconductor Manufacturing Company (TSMC) 0.18 μm complementary metal-oxide-semiconductor (CMOS) process. The operational amplifier 256 can be a single-stage fully differential amplifier. The pass transistor 252 (M₁) and the second transistor (M₂) can be native (zero-threshold) NMOS transistors to achieve low drop out voltage regulation. The desired output voltages, due to system design criteria, are the first output voltage, Vₒᵤₜ₁, equal to 1.9 volts and the second output voltage, Vₒᵤₜ₂, equal to 1.8 volts. In the example implementation, the first output voltage, Vₒᵤₜ₁, can supply voltage to analog circuitry and the second output voltage, Vₒᵤₜ₂, can provide supply voltage to digital circuitry.

Referring back to FIG. 6A, the waveform 602 can represent the voltage value of a supply voltage coupled to analog circuitry, where the voltage regulator can supply regulated, non-isolated voltages to mixed signal circuitry. The waveform 602 shows fluctuations in the voltage level due to the coupling of switching noise from digital circuitry onto the analog voltage supply. Referring to FIG. 6B, the waveform 652 can represent the voltage value of the first output voltage, Vₒᵤₜ₁, in the voltage regulator 250 in FIG. 2B. The first output voltage, Vₒᵤₜ₁, can be coupled to analog circuitry. The isolated, second output voltage, Vₒᵤₜ₂, can supply voltage to the digital circuitry. Since the first supply voltage, Vₒᵤₜ₁, and the second supply voltage, Vₒᵤₜ₂, can be isolated from one another, the switching noise from the digital circuitry, in all likelihood, may not be coupled onto the analog circuitry. The waveform 652 shows a reduction of approximately 26 dB in the fluctuations in the supply voltage.

In some implementations, FIG. 6A can show the simulated output voltage Vₒᵤₜ₁ when Vₒᵤₜ₁ is coupled to Vₒᵤₜ₂ and it is used as the supply voltage for both analog and digital circuits in the transponder chip. FIG. 6A shows fluctuations in Vₒᵤₜ₁ due to voltage and/or current switching in the digital circuits when Vₒᵤₜ₁ and Vₒᵤₜ₂ are tied together. FIG. 6B shows the simulated Vₒᵤₜ₁ when it is only used as the supply voltage for analog circuits in the chip and Vₒᵤₜ₂ is used as the supply voltage for the digital circuits in the transponder chip. FIG. 6B shows fluctuations in Vₒᵤₜ₁ due to switching in the digital circuits when Vₒᵤₜ₁ and Vₒᵤₜ₂ are not tied together.

Comparing FIGS. 6A and 6B reveals that the fluctuations in Vₒᵤₜ₁ due to the switching in the digital circuit are reduced by about 26 dB, when the multi-output regulator 250 is used to generate two isolated supply voltages for analog and digital circuits.

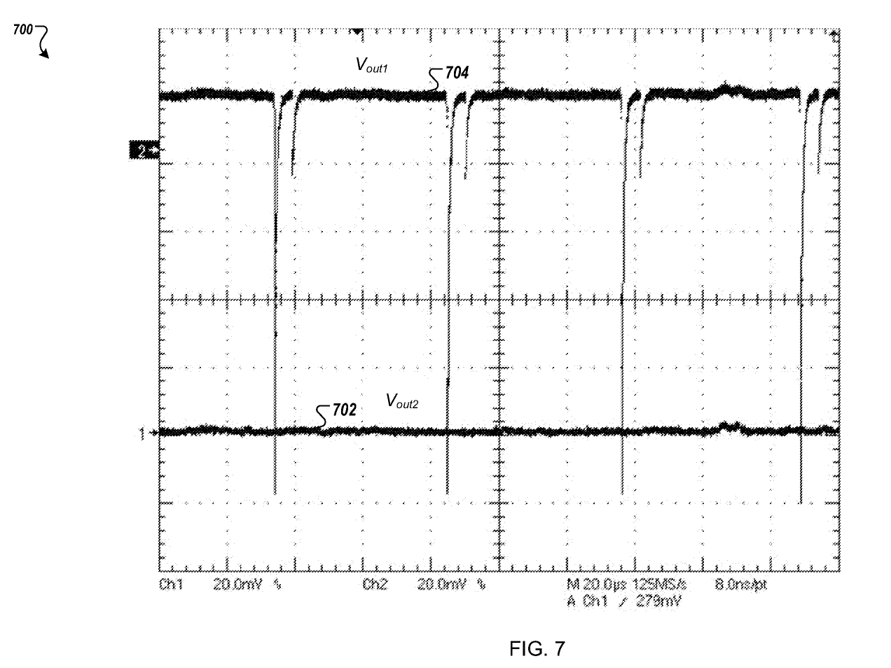

Referring to FIG. 7, a graph 700 can be of exemplary time-domain measurement results of a first output voltage waveform 702 and a second output voltage waveform 704, according to one embodiment. An oscilloscope can obtain the time-domain measurement results of the output voltages, resulting in the waveforms in the graph 700. Referring to FIG. 2B, the first output voltage, Vₒᵤₜ₁, (whose signal can be represented by the waveform 702) can supply voltage to analog circuitry and the second output voltage, Vₒᵤₜ₂, (whose signal can be represented by the waveform 704) can supply power to digital circuitry. In order to highlight the fluctuation in the first output voltage, Vₒᵤₜ₁, and the second output voltage 704, Vₒᵤₜ₂, due to the switching in the digital circuitry, the oscilloscope coupling is set to AC. The graph 700 shows that while there are sharp edges in the waveform 704 of the second output voltage, Vₒᵤₜ₂, due to switching noise in the digital circuitry, little to no fluctuation is visible in the waveform 702 of the first output voltage, Vₒᵤₜ₁.

Referring to FIG. 2B, for example, voltage regulator 250 can be optimized to deliver 100 μA of current to the first output voltage, Vₒᵤₜ₁, and 10 μA to the second output voltage, Vₒᵤₜ₂. The current consumption of the voltage regulator 250 can be 22 μA, of which 12 μA can be consumed in operational amplifier 256, and the reminder in the feedback resistors, resistor 258 (R_{F1}) and resistor 260 (R_{F2}). The circuit can exhibit a line regulation of 30 mV/V, a ripple rejection of 28 dB (at 13.56 MHz), and a dropout voltage of 120 mV for the first output voltage, Vₒᵤₜ₁, and the second output voltage, Vₒᵤₜ₂. The load regulation for the first output voltage, Vₒᵤₜ₁, can be 18 mV/mA, and the load regulation for the second output voltage, Vₒᵤₜ₂, can be 450 mV/mA.

FIG. 7 shows the time-domain measurement results of Vₒᵤₜ₁ and Vₒᵤₜ₂. In order to highlight the fluctuation in of Vₒᵤₜ₁ and Vₒᵤₜ₂ due to the switching in the digital circuits, the oscilloscope coupling is set to AC. FIG. 7 shows that while there are sharp edges in Vₒᵤₜ₂, very small fluctuations happen in Vₒᵤₜ₁.

A number of implementations have been described. Nevertheless, it will be understood that various modifications can be made without departing from the spirit and scope of the disclosed implementations. Accordingly, other implementations are within the scope of the following claims.

What is claimed is:

1. A system, comprising:
a circuit, wherein said circuit is configured to supply a plurality of regulated supply voltages, said circuit comprising:
a voltage regulator, wherein said voltage regulator includes a first transistor, wherein said first transistor is configured to supply a first regulated supply voltage; and
a second transistor, operably coupled to said first transistor, wherein said second transistor is configured to supply a second regulated supply voltage.

2. The system of claim 1, wherein said voltage regulator comprises:
an operational amplifier the output of which is operably coupled to said first transistor; and
at least two resistors operably coupled between an input to said operational amplifier and said first transistor.

3. The system of claim 2, wherein said at least two resistors and said first transistor comprise a feedback loop for said operational amplifier.

4. The system of claim 1, wherein said first regulated supply voltage is configured to supply power to analog circuit blocks and said second regulated supply voltage is configured to supply power to one or more of a digital circuit block, a radio frequency circuit block, and a memory circuit block.

5. The system of claim 1, wherein a gate of said first transistor is operably coupled to an output of said operational amplifier and a gate of said second transistor.

6. The system of claim 1, wherein:
a gate of said first transistor is operably coupled to an output of said operational amplifier; and
a gate of said second transistor is operably coupled on a drain or a source path of said first transistor.

7. The system of claim 1, wherein a gate of a third transistor is operably coupled to said gate of said first transistor.

8. The system of claim 1, wherein a value for said first regulated supply voltage is different from a value for said second regulated supply voltage.

9. The system of claim 1, wherein said voltage regulator comprises:
one or more diode-connected transistors operably coupled in series to one another;
said first transistor operably coupled to an end of said plurality of diode-connected transistors operably coupled in series to one another; and
a resistor operably coupled to said first transistor and said plurality of diode-connected transistors operably coupled in series to one another.

10. The system of claim 9, wherein a gate of said first transistor is operably coupled to said plurality of diode-connected transistors operably coupled to one another and a gate of said second transistor.

11. The system of claim 9, wherein:
a gate of said first transistor is operably coupled to said plurality of diode-connected transistors operably coupled to one another; and
a gate of said second transistor is operably coupled to a subset of said plurality of diode-connected transistors operably coupled to one another.

12. A multi-output voltage regulator, comprising:
a single-output linear voltage regulator generating a first output of said multi-output voltage regulator, wherein said first output is a first regulated supply voltage; and
at least one pass transistor, operably coupled to said single-output linear voltage regulator, wherein said pass transistor is configured to supply at least one additional regulated supply voltage.

13. The multi-output voltage regulator of claim 12, wherein said single-output linear voltage regulator is a series-type linear voltage regulator.

14. The multi-output voltage regulator of claim 12, wherein said single-output linear voltage regulator is a shunt-type linear voltage regulator.

15. The multi-output voltage regulator of claim 12, wherein the gate (base) terminals of said pass transistors are coupled to said single-output linear voltage regulator, and the drain (collector) terminals of said pass transistors are coupled to a power supply voltage.

16. A method for providing an electronic device configured to utilize a plurality of regulated supply voltages, said method comprising:
providing an electronic device;
configuring said electronic device to include a voltage regulator circuit, said voltage regulator circuit providing a plurality of regulated supply voltages, said plurality of regulated supply voltages connecting a first one of said regulated supply voltages to a portion of circuitry in said electronic device; and
connecting a second one of said regulated supply voltages to a different portion of circuitry in said electronic device.

17. The method of claim 16, wherein said portion of circuitry in said electronic device is an analog portion, and said different portion of circuitry in said electronic device is one or multiple of a digital portion, a radio frequency portion, and a memory portion.

18. The method of claim 16, further comprising configuring at least one of said plurality of regulated supply voltages to provide a different supply voltage than another of said plurality of regulated supply voltages.

19. The method of claim 16, further comprising isolating portions of circuitry of said electronic device from a single supply voltage from said voltage regulator circuit based on noise considerations for the respective portions.
